(19) United States
(12) Patent Application Publication
(10) Pub. No.: US 2010/0277793 A1
(43) Pub. Date: Nov. 4, 2010

(54) Optical System, Use of an Optical System and Object Viewing Method Using an Optical System

(76) Inventors: Christoph Hauger, Aalen (DE); Fritz Straehle, Heubach (DE); Ralf Kuschnereit, Oberkochen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/223,269

(22) PCT Filed: Jan. 22, 2007
(86) PCT No.: PCT/EP2007/000517

§ 371 Date: Jul. 25, 2008

(30) Foreign Application Priority Data
Jan. 25, 2006 (DE) 10 2006 003 575.5

(51) Int. Cl. G02B 21/22

(52) U.S. Cl. 359/381

(57) ABSTRACT

The invention relates to an optical system for observing an object, having a first system part with at least one observation beam path and at least one second system part with at least one other observation beam path, wherein the at least two system parts have a common or separate first imaging stage and a different second imaging stage, wherein the first imaging stage has an objective, wherein the second imaging stage of the first system part is designed as visual or digital and the second imaging stage of the second system part is designed as visual or digital, in which a visual imaging stage has at least one eyepiece and a magnification system with different lenses and in which a digital imaging stage has at least one camera adapter and a magnification system with different lenses, and wherein the second imaging stage of the second system part is designed in such a way that it makes possible a higher optical resolution of the object to be observed than the second imaging stage of the first system part. In addition, the invention relates to the use of such an optical system according to the invention as well as a method for observing an object with an optical system according to the invention.

The present invention relates to an optical system, particularly an operating microscope, for observing an object. In addition, the invention relates to the use of such an optical system as well as a method for observing an object with such an optical system.

Many types of optical systems for observing an object are known. Thus, among others, operating microscopes are utilized in medicine in order to detect tumors, e.g., in the brain and in ENT examination. Optical systems are also utilized, however, in many other fields for observing objects. Thus, such optical systems may be used, for example, for observing material samples, materials or liquids. Such optical systems also find application for observing substances in chemistry.

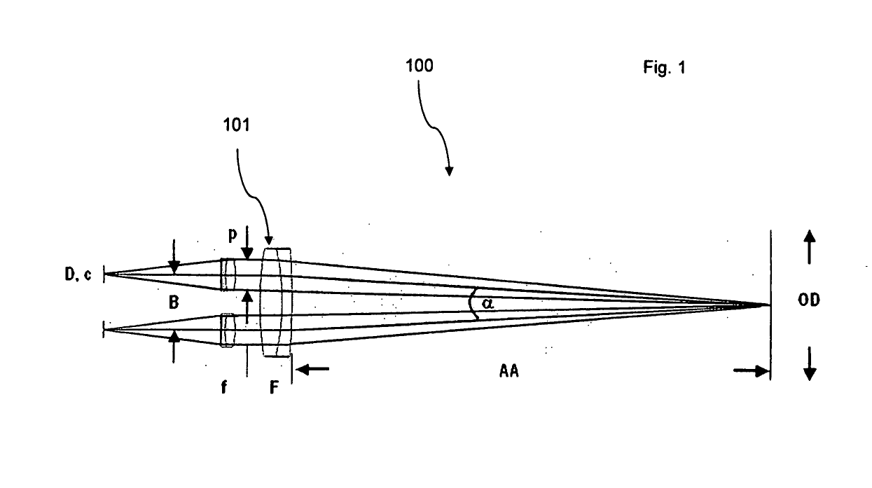

Operating microscopes can be described as two-stage imaging systems, which produce a real image of an object; see FIG. 1. In operating microscopes 100, a distinction is made between a visual and a digital operating microscope or between a visual and a digital imaging stage. In visual operating microscopes 100, observation in the operating microscope 100 is performed by an ocular unit or eyepiece, while in a digital operating microscope 100, the image is captured with a camera chip. The first imaging stage of an operating microscope 100 has an objective 101 with a focal length F, the so-called principal objective. Objective 101 may have a fixed focal length or may be designed as a so-called Varioscope, i.e., with a variable focal length. The objective is usually designed in such a way that both observation beam paths pass through objective 101 in a stereoscopic operating microscope 100.

The second imaging stage of an operating microscope 100 begins precisely at the site starting from which the two observation beam paths run separately. Usually the second imaging stage is made up of two sub-units. The first sub-unit is a magnification system or a zoom system, with different lenses. In the case of a visual operating microscope 100, the second sub-unit is the tube. In the case of a digital operating microscope 100, the second sub-unit is a camera adapter. The focal length of the second imaging stage is usually designated f. The image of the object which is produced by the two-stage imaging system is designated D for a visual operating microscope, and c for a digital operating microscope. In the case of a visual operating microscope, the image D is observed with an eyepiece, and in the case of a digital operating microscope 100, image c is usually shown on a display hooked up to the camera.

The magnification v of the total system is composed of the ratio of the focal lengths of the two imaging stages f/F. In the case of the visual operating microscope 100, the magnification of the eyepiece is added as a multiple. The working distance or operating distance AA, i.e., the distance between objective 101 and the object or the object field OD is determined by objective 101 of the first imaging stage. In known operating microscopes 100, the usual operating distance lies between 200 mm and 500 mm.

The numerical aperture NA of the imaging optics is a decisive factor for the optical resolution at the site of image D or c. The numerical aperture NA is the sine of half the aperture angle of objective 101 on the side of the object. The higher the value is for the numerical aperture, the greater also is the resolution capacity of an objective 101.

That is, the capacity of an objective 101 to resolve two adjacent details in the preparation depends on its numerical aperture NA. The following formula serves for calculating the theoretically possible optical resolution capacity of an objective 101 from the numerical aperture: d=λ/2·NA. λ is the wavelength of the light, d is the optical resolution, i.e., the distance between two points of the object which are still directly resolved. Decisive basic values are the pupil diameter p and the focal length of the principal objective F, from which the numerical aperture NA on the object side is calculated. The angle a denotes the stereo angle, which is calculated from the stereo base B and the focal length F.

The real image produced at site D or c must be recorded by means of a suitable detector. In the case of the visual operating microscope 100, the detector is the eye of the observer, who observes the image at site D through the eyepiece. In the case of the digital operating microscope 100, the detector is a camera chip, which is positioned directly at the site of image c.

An optical system with two system parts is known from the prior art. The first system part is for the most part a stereoscopic visual system part with two observation beam paths through which the surgeon observes the object, while the second system part is for the most part a monoscopic digital system part, wherein the observation beam path of this system leads to a camera. That is, in a conventional operating microscope, a first system part and a second system part are thus known, wherein the real image of the observed object is represented once visually and once digitally. The optical object resolution of the two real images is equal in the case of these known operating microscopes.

An operating microscope thus delivers to the observer a magnified view of the object or the surgical field and makes it possible for the surgeon to manipulate small tissue structures under optimal illumination. The range of magnification of an operating microscope lies in the range of 3.5 to 20×.

During surgery, there are a number of situations in which a clearly improved magnification lying in the cellular range would be desirable for diagnostic purposes, in the sense of an optical biopsy, i.e., not for the manual execution of the operation itself. The same holds true for observing extremely small structures. In order to observe material structures of objects which have spots, veins, grains, etc., for example, it is desirable to obtain a rather high magnification of the observed objects.

It is known from the prior art to remove tissue specimens in tissue structures during surgical interventions and to be able to have a pathologist examine these in vitro during the surgery. The result of this parallel investigation is of great importance for the further course of the operation. If, for example, a tumor is present, it must be removed as completely as possible. It is a disadvantage in the examination of the tissue structure, which is known from the prior art and is conducted in parallel to the observation of the object, that the tissue must first be removed from the object under investigation and then must be examined by another person, in particular a pathologist, in parallel to the surgery. In addition to the disadvantage relative to time expended, this procedure also has the disadvantage of higher cost, since, in addition, a pathological investigation must be conducted. Further, the object under investigation is damaged by the removal of a tissue specimen. This is particularly then a disadvantage, if it turns out in the subsequent examination that the tissue structure is healthy.

The object of the present invention is to create an optical system and a method, which make it possible, in a simple, rapid, and cost-effective way, to conduct an examination of tissue structures that have a size in the cellular range in an object, without introducing damage to the object. The optical system, particularly an operating microscope, will therefore make possible the simultaneous observation of an object with different resolutions, whereby the optical system will offer to the observer, in addition to the macroscopically possible optical resolution of a conventional operating microscope, an optical resolution in the cellular range.

The invention is based on the knowledge that this object can be accomplished by a single optical system, in particular an operating microscope, which can execute several functions.

The object is thus accomplished according to the invention by an optical system according to patent claim 1 and by a method according to patent claim 18. Further, the object is accomplished by the use of the optical system according to the invention according to claim 17. Additional configurations of the invention result from the dependent patent claims. Features and details which are described in connection with the optical system according to the invention thus apply also, of course, insofar as they are applicable, to the method according to the invention, and vice versa.

An optical system for observing an object, having a first system part with at least one observation beam path and at least one second system part with at least one other observation beam path, wherein the at least two system parts have a common or separate first imaging stage and a different second imaging stage, wherein the first imaging stage has an objective, wherein the second imaging stage of the first system part is designed as visual or digital and the second imaging stage of the second system part is designed as visual or digital, in which a visual imaging stage has at least one eyepiece and a magnification system with different lenses and in which a digital imaging stage has at least one camera adapter and a magnification system with different lenses, and wherein the second imaging stage of the second system part is designed in such a way that it makes possible a higher optical resolution of the object to be observed than the second imaging stage of the first system part, represents an optical system that makes it possible, in a simple, rapid, and cost-effective way, to conduct an examination of tissue structures that have a size in the cellular range in an object, without introducing damage to the object. The optical system according to the invention, particularly an operating microscope, will therefore make possible the simultaneous observation of an object with different optical resolutions. For example, the observer can observe the object macroscopically by means of the first system part, i.e., with an optical resolution lying in the usual range of a conventional operating microscope, and can observe a magnified representation of a partial region of the same object by means of the second system part.

The observer of the object or the surgeon receives a sufficient magnification, which usually lies in a range of 3.5-20×, for surgery on the object, by means of the first system part. Also, the observer or the surgeon can observe tissue structures of the object that are magnified by means of the second system part. This is not necessary in fact for a manual execution of the surgery itself on the object, but does make possible a detailed resolution of the tissue structures for the observer or the surgeon for diagnostic purposes. By means of the optical system according to the invention, the observer of an object or the surgeon can conduct both a detailed diagnosis of tissue structures and simultaneously an operation on the object with one and the same optical system. The removal of a tissue specimen with subsequent pathological investigation is superfluous, whereby, first of all, the object under investigation sustains no damage, and secondly, a considerable savings in time for establishing a diagnosis is possible. As objects that can be observed with such an optical system, in addition to human tissue structures, structures of materials can also be included. Thus, the objects may also be materials for clothing, metal samples, plastic samples or wood samples. Further, liquids can be observed simply and well with such an optical system. In particular, currents or a particle distribution can be well observed in liquids.

The optical system has a first system part with at least one observation beam path and at least one second system part with at least one other observation beam path. The two system parts can each have their own first imaging stage, each with its own objective. This solution for the optical system is expensive, of course, since switching from one objective to the other is necessary. The different objectives can be introduced into the observation beam path by means of a rotating mechanism. Several objectives, however, also mean increased costs.

For this reason, it is particularly advantageous, if the two system parts have a common first imaging stage, whereby the optical system, in particular an operating microscope, is designed in a simple and compact manner. A common first imaging stage saves costs in comparison to an optical system with separate first imaging stages. The first imaging stage has, in a particularly preferred manner, an objective with an infinite image width and a value range for the numerical aperture of 0.09 to 0.14. Infinite image width means here that the light beams reflected from the object run in parallel out from the side of the objective turned away from the object. Thus, a tube lens is additionally necessary for the formation of the microscopic intermediate image. The objective and the tube lens thereby form a functional unit. Due to the parallel course of the light beams, the distance between the objective and the tube lens can be varied. The possibility of providing the second system part in this region thereby results. An optical system having an objective with infinite focal length is compact, stable and flexible with respect to its constructability.

The objective advantageously has a value range for the numerical aperture NA of 0.09 to 0.14. This is necessary in order to make possible a high resolution of the object or of the tissue structures of the object. The numerical aperture of the first imaging stage determines the maximum possible optical resolution of the objective. An objective which has a numerical aperture NA with a value in the range between 0.09 and 0.14 makes possible a maximum optical resolution d of approximately 2-3 μm, whereby approximately 500-550 nm is taken as the value for the wavelength of light λ. Decisive criteria for the evaluation of a histological specimen or the dignity of a tumor are the cell variance, the cell nucleus variance and the nucleus-cytoplasm ratio. The diameter of human cells lies in the range of 10-20 μm. Cell nuclei have a diameter of approximately 5 μm. These small structures can be shown therewith, but the optical resolution of the optical system must be approximately 2.5 μm. The first imaging stage does not limit the optical resolution of the entire optical system, if the objective of the first imaging stage preferably has a numerical aperture with a value in the range between 0.09 and 0.14. A numerical aperture NA of the objective of the first imaging stage of 0.1 to 0.11 is particularly suitable, since with this range an optical resolution of tissue structures of an object is possible in the range of 2.5 μm. Further, a working distance, i.e., a distance between objective and object, of approximately 200 mm can be realized with such an objective.

The second imaging stages of the two system parts are designed differently according to the invention, wherein the second imaging stage of the second system part is designed in such a way that it makes possible a higher optical resolution of the object to be observed than the second imaging stage of the first system part. This makes it possible for the observer of the object to observe the object with different optical resolutions. The first system part represents a real image of the object with a smaller optical resolution than the second system part. The observer can observe the object first through the first system part of the optical system in order to obtain an overview of the tissue structure of the object. The first system part makes possible for him, for example, a stereoscopic observation of the object in the usual magnification and resolution range of a known operating microscope. In the best case, for a visual stereoscopic operating microscope according to the known prior art, this means that a resolution of approximately 5.5 μm is present at the site of the intermediate image. Converted to object sizes, an optical system in which the second imaging stage is designed as visual can therefore maximally optically resolve object structures in the range of approximately 6.5 μm. An optical system with this type of first system part makes possible the detection of critical sites within the tissue of the object, but does not make possible a detailed observation that would permit a diagnosis of the tissue structures.

Thus, an optical system is advantageous in which the optical resolution of the second imaging stage of the second system part is about 2.5 to 3.5 times higher than the optical resolution of the second imaging stage of the first system part. An optical system is particularly preferred in which the second imaging stage of the first system part is designed in such a way that it optically resolves objects of a size of down to 6.0 μm, and that the second imaging stage of the second system part is designed in such a way that it optically resolves objects of a size of down to 2.0 μm. In such an optical system, the first system part can be designed as a conventional operating microscope, which can optically resolve object structures in a range of approximately 6.5 μm, and the second system part represents a microscope with a higher resolution, which can optically resolve object structures in a range of approximately 2-3 μm.

In a visual imaging stage, at least one eyepiece and one tube lens are provided along with a magnification system with different lenses, and in a digital imaging stage, at least one camera adapter and a magnification system with different lenses are provided. The magnification system may also be designed as a zoom system.

The optical system according to the invention makes possible, for example, a stereoscopic observation of an object in the usual magnification and resolution range of an operating microscope as well as a simultaneous cellular resolution with clearly increased magnification and a reduced depth of field brought about thereby. In the scope of this invention, cellular resolution means an optical resolution in an order of magnitude of 2-3 μm. The optical system according to the invention preferably has a second system part with an optical resolution in the cellular range.

Further, an optical system is preferred, in which, due to the structure of the second imaging stage, the numerical aperture of the first system part on the object side is smaller than the corresponding numerical aperture of the second system part. Since the numerical aperture on the object side represents the determining measure for optical resolution, the optical resolution of the second system part is greater than that of the first system part. That is, for a common first imaging stage, the numerical aperture of the second system part on the object side is preferably larger by a factor of 3-3.5 than the numerical aperture of the second imaging stage of the first system part. An increase in the numerical aperture by a factor of 3 has as a consequence a reduction in the depth of field by a factor of 9, since the depth of field scales with the square of the numerical aperture. Since the numerical aperture of the objective is inversely proportional to the focal length of the objective, a focal length that is as small as possible is to be targeted for images with cellular resolution. A sufficiently great working distance, however, is a basic prerequisite for a successful surgical operation. Usually the working distance of an operating microscope lies between 200 mm and 500 mm. This makes possible a sufficient freedom of movement for the surgeon. Due to the requirement for a numerical aperture of 0.09-0.14 for the objective of the first imaging stage, the optical system for the case of an image with cellular resolution must be brought right in front of the object, i.e., with as short a working distance as possible. A working distance of approximately 200 mm would be a preferred working distance.

In order to separate the at least one other observation beam path, which runs through the second imaging stage of the second system part, from the at least one observation beam path which runs through the second imaging stage of the first system part, at least one beam splitter and/or at least one interruption element is provided. A beam splitter separates a portion of the light rays of the at least one observation beam path of the first system part, deflects these at a predetermined angle and thus forms the at least one other observation beam path of the second imaging stage of the second system part. Alternatively or in addition to the beam splitter, an interruption element can be provided. An interruption element in the sense of the invention is designed in such a way that individual or several regions of the interruption element can be switched between a highly transparent state and a diffuse state. Due to the possibility of switching one or several region(s) of the interruption element between a transparent and a diffuse state, the interruption element can execute several functions in the optical system. In the diffuse state, in which the interruption element has a high scatter effect, the region or regions of the interruption element seal(s) off parts of the beam path in which it is disposed, in particular, parts of the one or more observation beam path(s). Thus, an interruption element takes over the task of a partial shutter diaphragm or of so-called light traps. The regions of the interruption element do not hinder the observation beam path(s) in the transparent state. An interruption element may also represent a so-called block matrix. That is, the cross-sectional surface of the interruption element is divided into a plurality of blocks or rasters, wherein each individual block or each individual raster can be switched from a transparent state to a diffuse state. The interruption element may also be designed such that it has one or more tiltable indicators, wherein the end or the ends of the indicator(s) have a size of one or more rasters. The indicator(s) can mask targeted regions of an interruption element as needed and thus block parts of a beam path. The interruption element may also represent one or more mechanical or electrical diaphragm(s) which can be inserted into the observation beam path(s).

The interruption element preferably represents an electro-optical switch that can be controlled electronically. A rapid switching of the respective regions of the interruption element between the different states can be assured by the electronic control of the interruption element. In addition to the state of complete blocking of the beam, i.e., the diffuse state, or the state of complete passage of the beam, i.e., the transparent state, any state between the two extremes can also be realized. This is not possible with the use of a diaphragm as known from the prior art. Also, time courses can be adjusted in advance in this way, whereby a state pattern over time for the interruption element or for regions of the interruption element can be provided.

The interruption element preferably represents a liquid crystal polymer element (LCP) that can be electronically switched. This liquid crystal polymer element, which is designated in the following as the polymer shutter diaphragm or as the polymer shutter, is particularly advantageous, since, on the one hand, it can be reliably introduced into the two states that are necessary according to the invention, and, on the other hand, it has a very high speed of reaction relative to the control.

An optical element that operates on the basis of an electronically controllable light diffusion is particularly designated as a polymer shutter. This element is controlled by an external electrical field, the element being highly transparent due to the appropriate alignment of the crystals, if the electrical field is disconnected, and a higher degree of opacity, and therefore a high diffusion capacity, is provided to the liquid crystal polymer element by application of the electrical field. Polymer shutters operate with nonpolarized light and make possible a high transmission over the entire visible range. Polymer shutters that have a reaction time in the sub-millisecond range can be used as the liquid crystal polymer element.

The present invention is not limited to a specific embodiment of a polymer shutter. One possible embodiment can be formed, for example, by a pair of glass disks with an active layer disposed in between them, wherein the active layer contains free liquid crystal molecules. These can be obtained by a photopolymerization of liquid crystal polymer molecules in the presence of conventional liquid crystals. In the case of the polymer shutter, transparent electrodes can be used, for example, to introduce the electrical field. The voltage by which the polymer shutter can be loaded, can lie at 200 V, for example, whereby this represents the difference in the maxima of a voltage curve. For the operation of the polymer shutter, additional electrical connections only need to be provided to the polymer shutter(s). Controlling or activating the interruption element is understood in the sense of the invention as the moving of the interruption element or the individual regions of the interruption element into the diffuse state. For an interruption element that operates electronically, controlling thus means applying the necessary voltage in order to adjust the diffusion state. The optical device preferably has an activation device for controlling the first interruption element and the second interruption element. This activation device can be, for example, a switch, by means of which an interruption element or a region of the interruption element is activated.

The two system parts of the optical system can both be designed as monoscopic or as stereoscopic. In a particularly preferred embodiment of the optical system, the first system part is designed as stereoscopic and the second system part is designed as monoscopic. The stereoscopic design of the first system part makes it possible for the observer to first receive a first magnified image of the object. The magnification of the stereoscopic first system part is equivalent to that of a conventional operating microscope. The second system part, which makes possible a clearly higher resolution of the object in comparison to the resolution of the object of the first system part is preferably monoscopic in design. A monoscopic second system part is sufficient in order to observe a magnified representation of a partial region of the object on a display connected thereto.

Another preferred embodiment of the optical system provides that the observation beam paths of the first system part and of the second system part run parallel to one another, wherein the second imaging stage of the first system part and the second imaging stage of the second system part are each designed as digital, wherein a switching between the observation beam paths of the first system part and of the second system part is executed by a time-sequence control of the interruption element. If the camera chip of the digitally designed second imaging stage has very many pixels, in the high-resolving case, the observed object or the observed specimen can also be cellularly scanned.

Alternatively, for this purpose, by switching to the at least one other observation beam path of the second imaging stage of the second system part, another lens system can be introduced mechanically and/or electrically into the at least one other observation beam path of the second imaging stage of the second system part. The separation or switching from the first to the second system part is preferably executed via a polymer shutter, which has been mentioned above. That is, switching is conducted in a time sequence between the first system part and the second system part via the interruption element, wherein the first system part is preferably stereoscopic in design with a small numerical aperture and the second system part is monoscopic in design with a larger numerical aperture. In order to maintain the difference in the numerical aperture between the second imaging stage of the first and second system parts, an additional lens system can be introduced mechanically and/or electrically into the at least one other observation beam path of the second imaging stage of the second system part. Preferably, the additional lens system in introduced synchronously with the switching of the at least one interruption element into the at least one other observation beam path. Digital second imaging stages of the first and second system parts are particularly well suited for an optical system in which the observation beam paths of the first system part and the second system part run parallel to one another, since switching can be executed rapidly.

In addition, an optical system in which the exit pupil of the eyepiece of a visual second imaging stage lies in a value range between 0.5 mm to 1.0 mm, is of advantage. In this case, the total magnification of the optical system lies in the so-called necessary magnification range. In an optical system, such as an operating microscope, for example, the diameter of the device pupil which must be brought to cover the pupil of the eye of the observer is designated the exit pupil. The higher the magnification of the optical system is, the smaller the exit pupil is at the eyepiece, for the above given numerical aperture of the objective on the object side. Care is to be taken with respect to the diameter of the exit pupil of an optical system that the value does not go below 0.5 mm, since, if it did, a contrast-poor image would be observed by the eye due to diffraction effects. One then speaks of empty magnification. On the other hand, a value of more than 1 mm hardly introduces a further gain in perception, which is caused by the limited resolution capacity of the retina of the eye.

An embodiment of the optical system is preferred in which a digital second imaging stage of the second system part has a camera with a camera chip, wherein the pixel resolution of the camera connected to the camera adapter of a second imaging stage corresponds to the optical resolution at the site of the camera chip. The detector for a visual imaging stage is the eye of the observer who looks into the eyepiece. In the case of a digital imaging stage, the detector is the camera chip. The pixel size of the camera chip is a decisive factor in this case. According to the Nyquist theorem, a chip with a pixel size a can detect a minimum structure of size 2 a. This is designated the pixel resolution PA and the pixel cut-off frequency is the reciprocal thereof.

Further, an optical system is preferred, in which a focussing device is provided in a visual and/or digital second imaging stage of the first and/or the second system part. The focussing device can be operated manually or automatically via a so-called autofocus. The objective can be moved in the direction of the observed object by means of the focussing device. The focal plane can be adjusted in this way. It is particularly advantageous if the focussing device of a digital second imaging stage of the first and/or the second system part has an electro-optics. The focal plane can be adjusted very easily with this. A simple adjustment of the depth of field is particularly possible by means of an autofocus. Manual adjustment can be effected by means of an adjusting ring on the objective. Such a focussing device is also conceivable for the first imaging stage. The objective of the first imaging stage can be designed as a so-called Varioscope.

An optical system in which the beam splitter is mounted so that it can tilt is particularly advantageous. The beam splitter can be tilted in this way around one or more axes. The optical system advantageously has a tilting device by means of which the beam splitter can be tilted. By tilting the beam splitter, the measurement field of the second system part can be shifted. The measurement field represents the partial region of the object which can be observed with the second system part of the optical system. This partial region of the object that can be recognized by the second system part is represented by a higher optical resolution than the object that is observed by the first system part. The measurement field thus represents an excerpt from the object. The measurement field can be moved over the observed object by moving the beam splitter, i.e., any desired partial region of the object can be shown to the observer or to the surgeon that the latter would like to observe with higher optical resolution. The object or the object field observed by the first system part remains unchanged, while the partial region of the object, i.e., the measurement field can be moved variably over the object or the object field. By tilting the beam splitter, the observer can position the measurement field of the second system part with cellular resolution in the object field of the first system part. The positioning of the measurement field of the second system part can also be conducted automatically. In this way, the observer can determine places on the object that he sees by means of the first system part and then, by tilting the beam splitter, these places are approached by the second system part. Here, a displacement of the measurement field of the second system part is also conceivable by means of moving the pupil of the observer. For this purpose, the optical system can have a measuring instrument that records the movement and viewing direction of the observer's eye and a control unit that moves the measurement field as a function of this viewing direction. The beam splitter can preferably be designed as a scanning mirror.

The image of the measurement field of the second system part can be imaged so that it can be observed on an image screen connected to the camera. The image may also be reflected, however, into the observation beam path(s) of the first system part, particularly a system part that is stereoscopic in design. The reflecting can be conducted permanently or sequentially.

Further, an optical system is advantageous, in which the second imaging stage of the first and/or the second system part has a zoom system. In this way, different focal lengths can be adjusted.

The objective of the first imaging stage of the optical system, as mentioned previously, should have a numerical aperture in the value range of 0.09 to 0.14. The objective can be designed as a teleobjective. A positive group, i.e., a convergent lens is found first in the beam path in the teleobjective, followed by a negative group, a so-called divergent lens, whereby the working distance of the objective is shorter than the focal length. Further, an optical system is preferred, in which the objective of the first imaging stage is a retrofocus objective. The term retrofocus designates a special construction of objectives with short focal length. The retrofocus construction is the reverse of the tele structure of objectives. That is, in retrofocus objectives, the sequence is reversed, whereupon the working distance is enlarged. The retrofocus objective has the advantage that the focal length is less than the working distance of the objective to the object and thus makes possible a high aperture. With a retrofocus objective, a numerical aperture in the value range of 0.09 to 0.14 can be realized in a particularly simple manner.

The use of one of the above-mentioned optical systems for observing an object with at least two different resolutions makes possible a “coarse” and a “detailed” observation of an object for the observer or the surgeon. In particular, on the one hand, with the use of an optical system according to the invention, an observation of an object can be conducted in a conventional magnification range, and, on the other hand, an observation of a partial region of the object can be made in a cellular range.

Further, the object is accomplished by a method for observing an object with an optical system according to the invention as has been described above, in which the observer magnifies the object by the at least one observation beam path of the first system part and then can observe a partial region of the object magnified once more by the observation beam path of the second system part. Thus, the observer of the object can first observe the object with the first system part of the optical system in a magnification necessary for surgery, wherein the magnification usually lies in a range of 3.5 to 20×. This observation of the object by the first system part is also called macroscopic observation. The observer can observe partial regions of the objects that are magnified once more by the second system part, whereby here optical resolutions in the cellular range are possible. In the sense of the invention, cellular resolution means that the resolution of the second imaging stage of the second system part of the optical system resolves down to 2 μm. The observer or the surgeon can observe extremely small tissue structures in this way, in particular, cell nuclei.

In particular, a method for observing an object with an optical system as has been described above is preferred, in which the observer of the object can observe a partial region of the object that is magnified 2.5 to 3.5 times more by the at least one other observation beam path of the second system part when compared to the magnification by the at least one observation beam path of the first system part. In this way, optical resolutions in the second system part of the optical system of down to 2 μm are possible, while optical resolutions of approximately 6.5 μm can be achieved by the first system part of the optical system.

Further, a method is advantageous, in which the at least one interruption element and the other lens system are introduced via an activation device into the at least one other observation beam path of the second imaging stage of the second system part. Both system parts of the optical system are digital in design, so they can be switched back and forth between the first system part and the second system part via the at least one interruption element. By activating the activation device, the at least one interruption element and the other lens system are introduced into or removed from the at least one other observation beam path of the second imaging stage of the second system part. It is thus particularly advantageous if the other lens system are introduced into the at least one other observation beam path of the second imaging stage of the second system part, or the other lens system is removed from the at least one other observation beam path of the second imaging stage of the second system part synchronously relative to the switching of the at least one interruption element. In the case of a digital second imaging stage of the optical system, the switching between the two system parts is conducted in a particularly simple and rapid manner.

A method in which a focussing is conducted manually or by an autofocus with a visual imaging stage of the first and/or the second system part represents another advantageous method. In this way, the focal lengths of the first and the second imaging stages of the optical system can be changed in a simple manner. The depth of field can be influenced by changing the focal lengths.

An electro-optics can be provided for rapid variation of the focal lengths of the first and/or the second system part. A method is therefore advantageous, in which a focussing is carried out based on evaluating the contrast of the camera images in the case of a digital imaging stage of the first and/or the second system part. The focal length can be automatically adjusted to the desired contrast setting by evaluating the images with respect to their contrast.

In the case of objects at rest, the optical system can be focussed by a manual or automatic adjustment of the focal length, i.e., the range of depth of field can be adjusted. This can be realized, in particular, in a visual imaging stage.

In the case of operations on a moving object with the use of the usual stands or supports, there are movements caused thereby, e.g., breathing movements in the case of a human object, or due to device vibrations, these are relative movements between the optical system and the object, which are large enough that a visual second imaging stage does not fulfill the requirement for focussing. In such a case, the second imaging stage of the first and/or the second system part should have a digital design. That is, since the depth of field is very small and the patient and the system always move slightly relative to one another, e.g., by the breathing or the heart beat of the patient, it is only possible in practice to electronically capture a highly resolved image. In addition to a rapid autofocus, the use of a camera with a high frame rate and short exposure times is particularly advantageous. With the use of a camera with a high frame rate and short exposure times, a stack of images can be recorded by through focussing and a “sharp” image can be selected from this stack of images. It is also conceivable to compose the “sharp” image from different images from the stack of images.

Further, a method is of advantage in which a partial region of the object that is visible to the observer by means of the first system part can be variably determined by changing the at least one other observation beam path of the second system part. That is, the at least one other observation beam path of the second system part can be changed such that the measurement field, i.e., the partial region of the object which is represented by the second system part, can be represented smaller or larger or can be shifted in its position relative to the overall object. This can be done by means of the previously described interruption element. A polymer shutter is particularly very well suitable for changing the partial region of the object. Each time depending on the desired image size of the measurement field, the aperture of the polymer shutter can be adjusted x times smaller or x times larger. In this way, the size of the measurement field of the second system part, in particular, can be changed.

Further, a method is preferred in which the at least one other observation beam path of the second system part is changed by tilting the beam splitter or the scanning mirror. In this way, the position of the partial region of the object that is observed can be variably adjusted. That is, the measurement field of the second system part of the optical system can be shifted over the entire object. This shifting is carried out as a function of the inclination of the beam splitter or scanning mirror. The beam splitter or the scanning mirror is disposed in the at least one observation beam path of the first system part of the optical system and can be rotated around one or more axes. In this way, the measurement field can be shifted into any desired position.

Further, a method is preferred for observing an object with a previously described optical system according to the invention, in which the magnified image that is shown of the partial region of the object, which is represented on a display device connected to the camera of the second system part, is projected into the at least one observation beam path of the first system part. This makes it possible for the observer or the surgeon to observe a partial region of the object with higher resolution, without changing his own position. He can observe, for example, by the first system part, both the entire object with a first resolution as well as also a partial region of the object with a second resolution that is higher than the first resolution. This is particularly simple to realize in an optical system with digital second imaging stages for both system parts. The observer does not need to remove his view from the first system part and turn his attention to a display device belonging to the second system part, but can keep his view unchanged in order to observe the object with two different resolutions. For this purpose, the image represented in the second system part projects back into the at least one observation beam path of the first system part and is represented in a corresponding conjugated plane within the at least one observation beam path.

Further, a method is preferred, in which the observer of the object that is observed by the first system part selects specific positions on the object, which can be brought up one by one by changing the at least one other observation beam path of the second system part and can be represented in the at least one other observation beam path of the second system part. That is, the observer marks different places in the object field that can then be brought up automatically by a corresponding positioning of the beam splitter. This has the advantage that the observer of the object first obtains a good overview of critically appearing tissue structures with the so-called macroscopic observation of the object by means of the first system part, which he can mark in order to bring these up automatically and can represent them with increased resolution by means of the second system part. Due to the possibility of first marking and then the subsequent automatic bringing up of the marked points, errors cannot arise in the sense that critical sites are not overlooked or are not simply forgotten to be brought up and represented in an enlarged manner.

In addition, it is not possible in practice, for reasons of time, to survey large areas of tissue with cellular resolution. For this reason, the combination with a method that surveys surfaces is meaningful, by means of which larger areas of tissue are detected and suspect regions can be identified. The suspect areas are subsequently exclusively surveyed with cellular resolution. In this way, the expenditure of time for surveying is greatly reduced.

Suitable surface-surveying methods for identifying suspect tissue areas are optical coherence tomography, fluorescence and autofluorescence methods, Raman spectroscopic methods or methods that detect polarization and diffusion properties of tissue.

The optical system according to the invention represents an observation device, in particular an operating microscope.

The invention will be explained in detail below based on embodiment examples with reference to the appended drawings. Here:

FIG. 1 shows schematically the basic structure of an operating microscope;

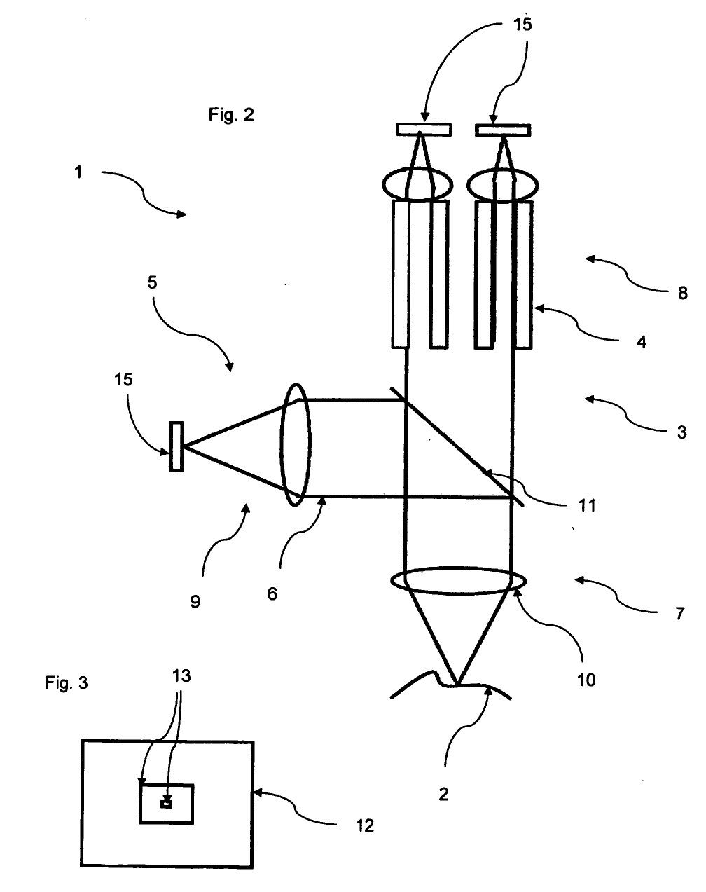

FIG. 2 shows schematically the structure of an optical system according to the invention with stereoscopic and monoscopic beam paths;

FIG. 3 shows image excerpts of a stereoscopic observation beam path relative to a monoscopic observation beam path;

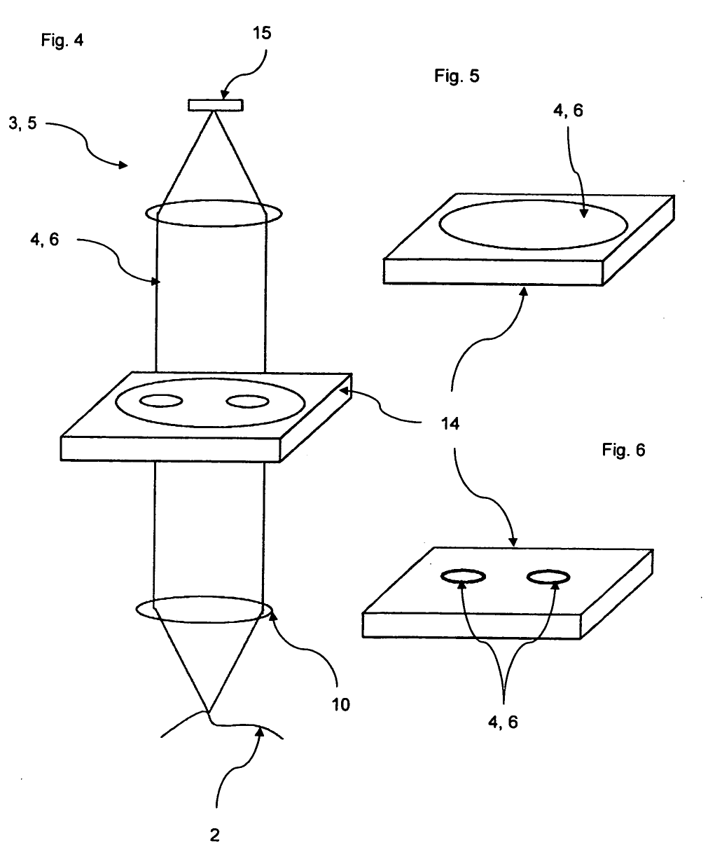

FIG. 4 shows another embodiment of an optical system 1;

FIG. 5 shows an interruption element which is switched so that the observation beam path is monoscopic in form;

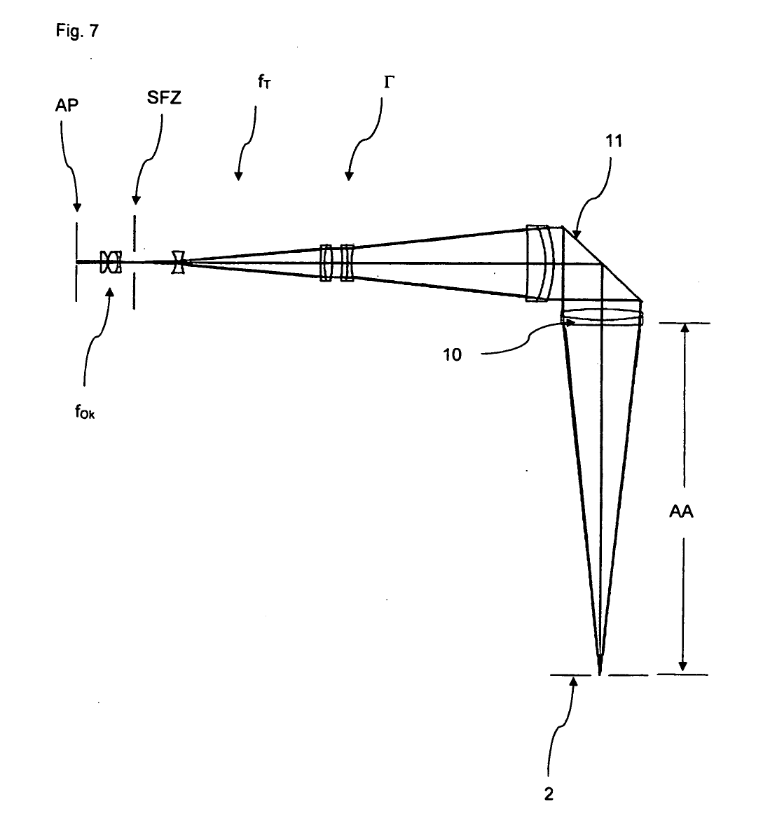

FIG. 6 shows an interruption element which is switched so that the observation beam path is stereoscopic in form;

FIG. 7 shows the representation of a high-resolving optics for an embodiment of a visual optical system;

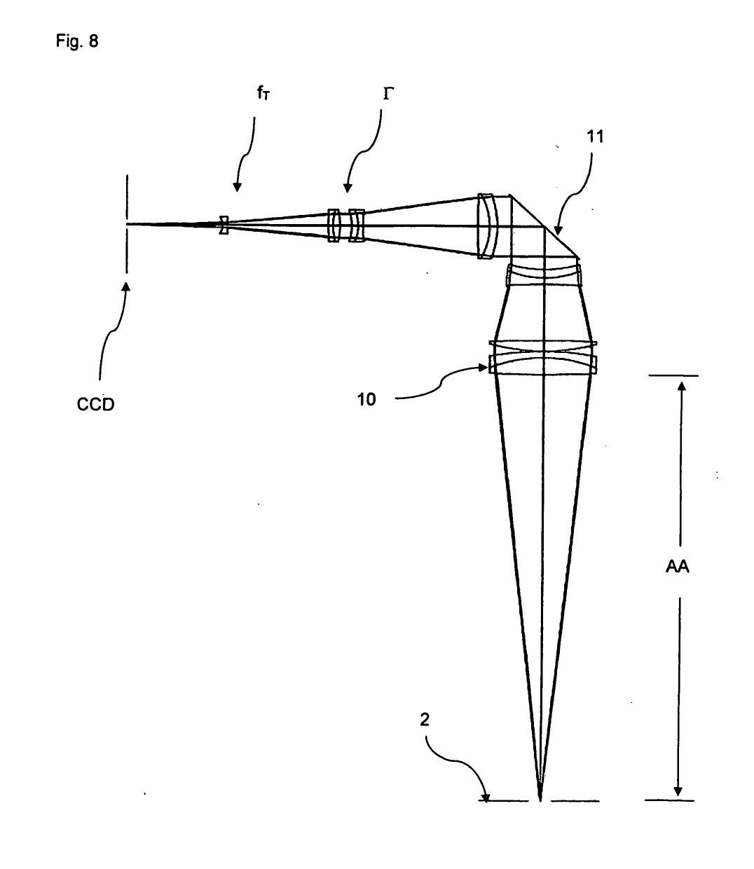

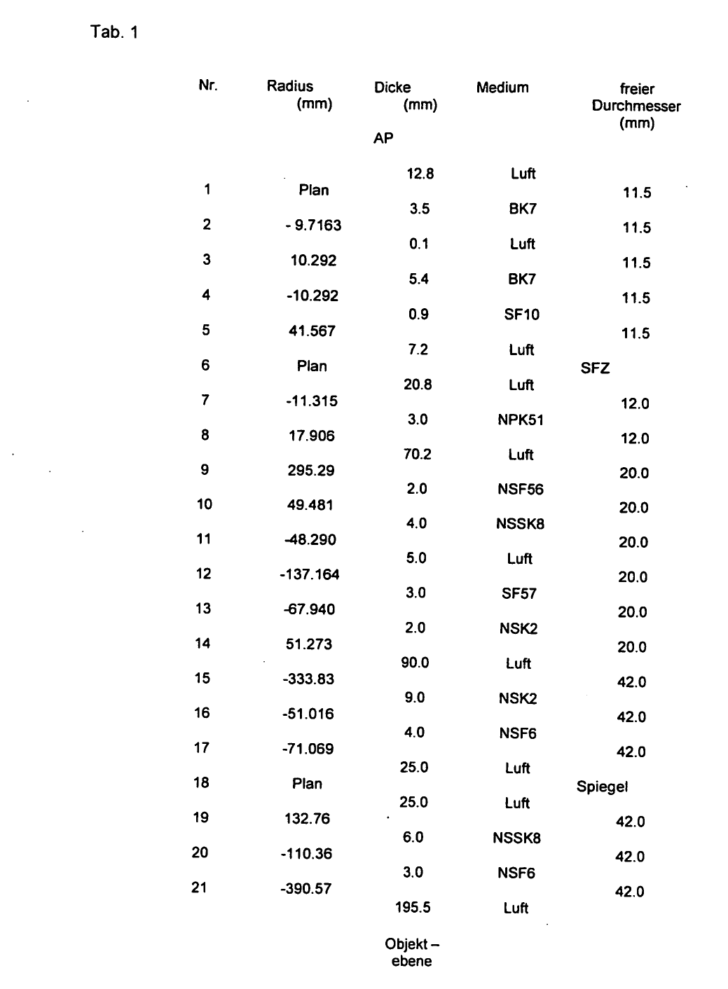

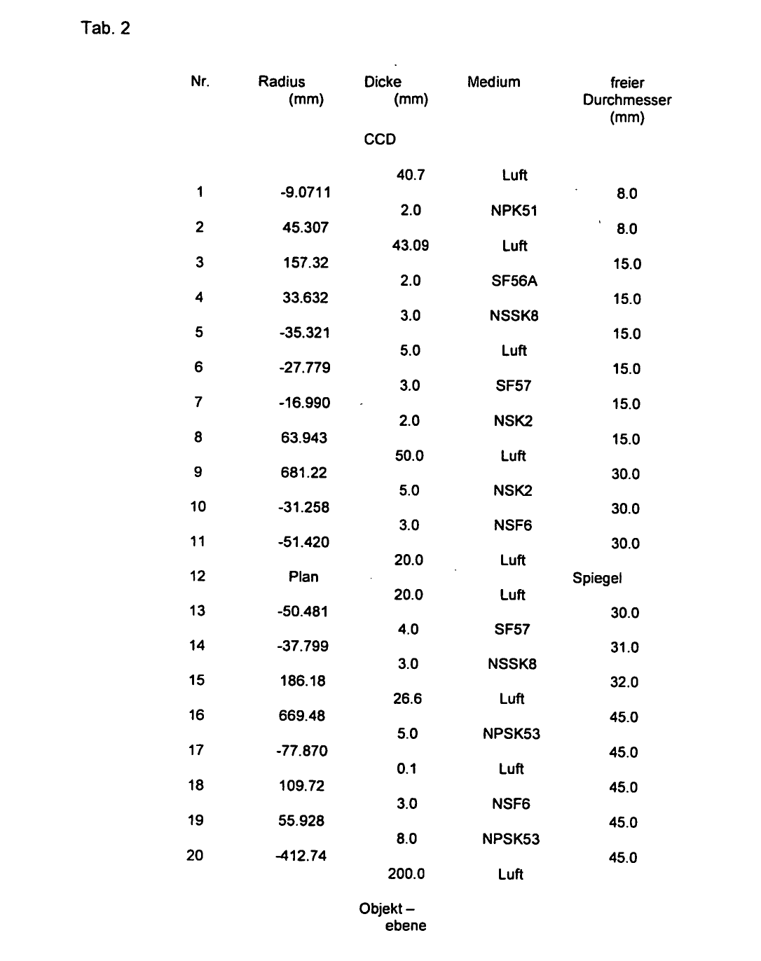

FIG. 8 shows the representation of a high-resolving optics for an embodiment of a digital optical system;

Table 1 shows possible system data for a visual optical system;

Table 2 shows possible system data for a digital optical system.

FIG. 2 shows schematically the structure of an optical system 1 according to the invention. Optical system 1 serves for observing an object 2, such as, for example, a material sample. Optical system 1 has a first system part 3 with at least one observation beam path 4 and at least one second system part 5 with at least one other observation beam path 6, wherein the at least two system parts 3, 5 have a common first imaging stage 7, and a different second imaging stage 8, 9. It is also conceivable that the at least two system parts 3, 5 have a separate first imaging stage 7. The first imaging stage 7 has an objective 10 with an infinite image width and a value range for the numerical aperture NA of 0.09 to 0.14. The second imaging stage 8 of the first system part 3 can be designed as visual or digital and the second imaging stage 9 of the second system part 5 can also be designed as visual or digital. A visual imaging stage has at least one eyepiece and a magnification system with different lenses and a digital imaging stage has at least one camera adapter and a magnification system with different lenses. The second imaging stage 9 of the second system part 5 of optical system 1 according to the invention is designed in such a way that it makes possible a higher optical resolution of the object 2 to be observed than the second imaging stage 8 of the first system part 3.

The optical system 1 in FIG. 2 shows a stereoscopically designed second imaging stage 8 of the first system part 3 and a monoscopically designed second imaging stage 9 of the second system part 5. The stereoscopically designed second imaging stage 8 of the first system part 3 and the monoscopically designed second imaging stage 9 of the second system part 5 are separated after the first imaging stage 7 by means of a beam splitter 11. Cameras 15 can be provided at the ends of the observation beam paths 4, 6.

The simultaneous observation of an object 2 with different optical resolutions is made possible by optical system 1 according to the invention. For example, the observer can observe object 2 macroscopically by means of the first system part 3, i.e., with an optical resolution lying in the usual range of a conventional operating microscope, and also can observe a further magnified representation of a partial region of the same object 2 by means of the second system part 5.

The optical system makes it possible, in a simple, rapid, and cost-effective manner, to conduct on an object 2 an investigation of tissue structures which have a size in the cellular range, without introducing damage to object 2.

A maximum optical resolution d of approximately 2-3 μm can be made possible by an objective 10 which has a numerical aperture NA with a value in the range between 0.09 and 0.14, wherein approximately 500-550 nm is taken as the value for the wavelength of light λ. The diameter of human cells lies in the range of 10-20 μm. Cell nuclei have a diameter of approximately 5 μm. Thus, if these small structures are to be shown, the optical resolution of the optical system must be approximately 2.5 μm. The first imaging stage 7 does not limit the optical resolution of the entire optical system 1, if objective 10 of the first imaging stage 7 preferably has a numerical aperture with a value in a range between 0.09 and 0.14. A numerical aperture NA of the objective of 0.1 to 0.11 for the first imaging stage 7 is particularly preferred, since with this range an optical resolution of tissue structures of an object 2 is possible in the range of 2.5 μm. Further, a working distance AA, i.e., a distance between objective 10 and object 2, of approximately 200 mm can be realized with such an objective 10.

By means of optical system 1 according to the invention, the observer of an object 2 or the surgeon can conduct both a detailed diagnosis of tissue structures and simultaneously perform an operation on object 2 with one and the same optical system 1. A removal of a tissue specimen with subsequent pathological investigation is superfluous, whereby, first of all, the object 2 under investigation sustains no damage, and secondly, a considerable savings in time for establishing a diagnosis is possible.

FIG. 3 shows excerpts from the image of the stereoscopic observation beam path 4 relative to the monoscopic observation beam path 6 for a purely digital optical system 1. The image excerpt 12 of the stereoscopic observation beam path 4 is larger than the image excerpt 13 of the monoscopic observation beam path 6. The size of image excerpt 13 with cellular resolution changes only relative to image excerpt 12 of the stereoscopic observation beam path 4. For example, a magnification system with a 6× zoom can be used for stereoscopic observation beam path 4.

Another embodiment of an optical system 1 is shown in FIG. 4. The stereoscopic observation beam path 4 of the first system part 3 runs parallel to the monoscopic observation beam path 6 of the second system part 5. The stereoscopic observation beam path 4 and the monoscopic observation beam path 6 run parallel, i.e., pass through the same optical elements. A separation of the two system parts 3, 5 occurs in a time sequence. A switching between the stereoscopic observation beam path 4 with small aperture and the monoscopic observation beam path 6 with large aperture sequentially in time one after the other is carried out via a suitable interruption element 14, particularly a shutter element, such as, for example, a polymer shutter. Such an optical system 1 is advantageously designed exclusively as a digital system, whereby both observation beam paths 4, 6 are detected by a camera.

In the embodiment of optical system 1 according to FIG. 4, switching can be conducted by means of a suitable electro-optics or a switchable conventional optics in the second imaging stage 8, 9, whose focal length can be switched synchronously to interruption element 14. Thus, a switching of magnifications between the stereoscopic and the monoscopic beam paths in a synchronous manner to interruption element 14 is possible. That is, switching is conducted in a time sequence between the first system part 3 and the second system part 5 via the interruption element 14, wherein the first system part 3 is preferably stereoscopic in form with a small numerical aperture and the second system part 5 is monoscopic in form with a larger numerical aperture. In order to obtain the difference in the numerical aperture between the second imaging stages 8, 9 of the first and second system parts 3, 5, an additional lens system (not shown) can be introduced mechanically and/or electrically into observation beam path 6 of the second imaging stage 9 of the second system part 5. Digital second imaging stages 8, 9 of the first and the second system parts 3, 5 are particularly well suited to an optical system 1, in which the observation beam paths 4, 6 of the first system part 3 and the second system part 5 run parallel to one another, since switching can be rapidly conducted.

FIG. 5 shows an interruption element 14, which is switched in such a way that observation beam paths 4, 6 are monoscopic, while in FIG. 6 the interruption element 14 is switched in such a way that observation beam paths 4, 6 are stereoscopic.

Concrete optical system data for high-resolving optic components of a visual optical system 1 according to the invention and of a digital optical system 1 according to the invention are described in the following.

The high-resolving optics for an embodiment of a visual optical system 1, in particular for an operating microscope, are shown in FIG. 7. The optics for the visual optical system 1 consist of the following optics components:
a principal objective 10 with fixed focal length and having a focal length of F=200 mm and a free working distance of AA=196 mm, i.e., the distance between principal objective 10 and object 2 or the object field.
a magnification system, a so-called afocal Galileo system with a magnification factor of Γ=2.5.
a tele-tube with a focal length of f_{T}=224 mm.
an eyepiece 20×/10 with a magnification of V_{oc}=20, a visual field number VFN=10 and an eyepiece focal length f_{oc}=250/V_{oc}=12.5 mm.

The numerical aperture on the object side amounts to NA=0.1, so that an object resolution of δ=2.5μ results.

The total focal length of the Galileo system and tele-tube results as F_{T}=Γf_{T}=560 mm. The object-intermediate image imaging scale factor β is the ratio β=F_{T}/F=2.8.

The object field with diameter 3.6 mm is thus magnified by β in the eyepiece intermediate image with the visual field diameter of 10 mm.

The telescopic magnification V_{F} comprised of Galileo system, tube and eyepiece amounts to V_{F}=F_{T}/f_{oc}=45.

The pupil diameter of 40 mm in the telescope entrance then results in an exit pupil AP of AP=40/V_{F}=0.9 mm and thus lies within the required magnification range of 0.5-1.0 mm.

The optical system data for the visual OPMI are listed in Table 1.

The high-resolving optics for an embodiment of a digital optical system 1, in particular for an operating microscope, are shown in FIG. 8. The optics for the digital optical system 1 consist of the following optics components:
a retrofocus principal objective with a focal length of F=140 mm and having a free working distance of AA=200 mm, i.e., the distance between principal objective 10 and object 2 or the object field.
a magnification system, a so-called afocal Galileo system with a magnification factor of Γ=2.5 as well as
a tele-tube with a focal length of f_{T}=224 mm.

The numerical aperture on the object side amounts to NA=0.1, so that an object resolution of δ=2.5μ results.

The total focal length of the Galileo system and tele-tube amounts to F_{T}=Γf_{T}=560 mm.

The imaging scale factor β from the object plane to the sensor surface of the CCD amounts to β=F_{T}/F=4.0.

Therefore, an object of diameter of 2.5μ magnified to 10μ is imaged on the CCD and can be resolved still further by the image sensor with a pixel size of 5μ. Since the chip diagonal of 4.6 mm represents the limit of the image field that is imaged, an object field diameter of 4.6 mm/4.0=1.2 mm results.

The optical system data for the visual OPMI are listed in Table 2.

Possible system data of a visual optical system 1 and a digital optical system 1 are shown in Tables 1 and 2.

1. An optical system for observing an object, having a first system part with at least one observation beam path and at least one second system part with at least one other observation beam path, wherein the at least two system parts have a common or separate first imaging stage, and a different second imaging stage, wherein the first imaging stage has an objective, wherein the second imaging stage of the first system part is designed as visual or digital and the second imaging stage of the second system part is designed as visual or digital, in which a visual imaging stage has at least one eyepiece and a magnification system with different lenses and in which a digital imaging stage has at least one camera adapter and a magnification system with different lenses, and wherein the second imaging stage of the second system part is designed in such a way that it makes possible a higher optical resolution of object that is to be observed than the second imaging stage of the first system part.

2. The optical system for observing an object according to claim 1, further characterized in that the optical resolution of the second imaging stage of the second system part is about 2.5 to 3.5 times higher than the optical resolution of the second imaging stage of the first system part.

3. The optical system for observing an object according to claim 1, further characterized in that the second imaging stage of the first system part is designed in such a way that it optically resolves objects of a size of down to 6.0 μm, and that the second imaging stage of the second system part is designed in such a way that it optically resolves objects of a size of down to 2.0 μm.

4. The optical system for observing an object according to claim 1, further characterized in that the numerical aperture of the second imaging stage of the first system part is smaller than the numerical aperture of the second imaging stage of the second system part.

5. The optical system for observing an object according to claim 1, further characterized in that at least one beam splitter and/or at least one interruption element is provided, by which means the at least one other observation beam path, which runs through the second imaging stage of the second system part, can be separated from the at least one observation beam path, which runs through the second imaging stage of the first system part.

6. The optical system for observing an object according to claim 1, further characterized in that the first system part is stereoscopic and the second system part is monoscopic in form.

7. The optical system for observing an object according to claim 5, further characterized in that the observation beam paths of the first system part and of the second system part run parallel to one another, wherein the second imaging stage of the first system part and the second imaging stage of the second system part are each digital in design, wherein a switching between the observation beam paths of the first system part and the second system part is executed by a time-sequence control of the interruption element.

8. The optical system for observing an object according to claim 7, further characterized in that, when switching to the at least one other observation beam path of the second imaging stage of the second system part, another lens system can be introduced mechanically and/or electrically into the at least one other observation beam path of the second imaging stage of the second system part.

9. The optical system for observing an object according to claim 1, further characterized in that the exit pupil of the eyepiece of a visual second imaging stage lies in a value range between 0.5 mm and 1.0 mm.

10. The optical system for observing an object according to claim 1, further characterized in that a digital second imaging stage of the second system part has a camera with a camera chip, wherein the pixel resolution of the camera connected to the camera adapter of a second imaging stage corresponds to the optical resolution at the site of the camera chip.

11. The optical system for observing an object according to claim 1, further characterized in that a focussing device is provided in a visual and/or digital second imaging stage of the first and/or the second system part.

12. The optical system for observing an object according to claim 11, further characterized in that the focussing device of a digital second imaging stage of the first and/or the second system part has an electro-optics.

13. The optical system for observing an object according to claim 5, further characterized in that the beam splitter is mounted so that it can be tilted.

14. The optical system for observing an object according to claim 5, further characterized in that the beam splitter is a scanning mirror.

15. The optical system for observing an object according to claim 1, further characterized in that the second imaging stage of the first and/or the second system part has a zoom system.

16. The optical system for observing an object according to claim 1, further characterized in that the objective of the first imaging stage is a retrofocus objective.

17. A use of an optical system according to claim 1 for observing an object with at least two different resolutions.

18. A method for observing an object with an optical system according to claim 1, in which the observer magnifies the object by the at least one observation beam path of the first system part and can observe a partial region of the object magnified once more by the observation beam path of the second system part.

19. The method according to claim 18, further characterized in that the observer of object can observe a partial region of object by means of the at least one other observation beam path of the second system part that is magnified 2.5 to 3.5× compared to the image observed by means of the at least one observation beam path of the first system part.

20. The method according to claim 18, further characterized in that the at least one interruption element and the other lens system are introduced via an activation device into the at least one other observation beam path of the second imaging stage of the second system part.

21. The method according to claim 18, further characterized in that focussing is conducted manually or by an autofocus for a visual imaging stage of the first and/or the second system part.

22. The method according to claim 18, further characterized in that focussing is carried out based on evaluating the contrast of the images of camera in the case of a digital imaging stage of the first and/or the second system part.

23. The method according to claim 18, further characterized in that a partial region of object that is visible to the observer by means of the first system part can be variably determined by changing the at least one other observation beam path of the second system part.

24. The method according to claim 18, further characterized in that the at least one other observation beam path of the second system part is changed by tilting the beam splitter or the scanning mirror.

25. The method according to claim 18, further characterized in that the enlarged image of the partial region of object, which is represented and which is shown on a display device connected to camera of the second system part, is projected into the at least one observation beam path of the first system part.

26. The method according to claim 18, further characterized in that the observer of object, which is observed by means of the first system part, selects specific positions on object, which can be brought up one by one by changing the at least one other observation beam path of the second system part and can be represented in the at least one other observation beam path of the second system part.

27. The method according to claim 18, further characterized in that the selection of the partial region of object shown in the second system part is carried out with the help of an autofluorescence method.
